(19) United States
(12) Patent Application Publication
(10) Pub. No.: US 2008/0217423 A1
(43) Pub. Date: Sep. 11, 2008

(54) Single-Dose Spray Container, Spray Tip and Single-Dose Spray Kit

(75) Inventors: Francois Andro, Hede (FR); Eric Armand, Saint Malo (FR); Matthew Stubbings, Dinard (FR); Camille Schmit, Rennes (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Laboratoire De La Mer

(21) Appl. No.: 12/025,383

(22) Filed: Feb. 4, 2008

(30) Foreign Application Priority Data
Feb. 5, 2007 (FR) FR 07 00808

(51) Int. Cl. B05B 17/04; B65D 1/32; A62C 31/02

(52) U.S. Cl. 239/11; 239/327; 239/589

(57) ABSTRACT

The invention relates to a single-dose container fitted with a spray tip comprising a generally cylindrical nozzle, the upper end of which comprises a spray opening and the opposite end of which is extended by a plunger of smaller diameter, the free end of which is mechanically reinforced, the nozzle and the plunger being crossed along their longitudinal axis by a traversing cavity, said traversing cavity having at the nozzle a means of creating droplets; it also relates to the actual tip and to a spray kit comprising said nozzle and a pre-filled single-dose bottle.

The present invention relates to a single-dose spray container, a spray tip and a single-dose spray kit. These elements are disposable or reusable and allow an atomization using a single-dose container, the form of which may or may not be defined.

Single-dose plastic bottles are very widely used for the administration of pharmaceutical or cosmetic products that are perishable and/or require several applications per day, in particular because of the conveniences of transport and use that they offer.

However, these single-dose bottles have the drawback that the liquid that they contain flows in a jet when a pressure is exerted on their side-wall. For some applications, the jet is too strong, in particular in the case of application to nasal mucous membranes of infants and children, or else the jet is too localized, in particular for topical applications of disinfectant or cosmetic products. An administration by spraying is therefore preferred so as to make the contact less strong, to increase the surface area of product applied in one go to the zone to be treated and/or to increase the penetration of the product applied to the mucous membrane in particular.

Spray tips are described in particular in the following patents: WO 97/07897, FR 840 549, U.S. Pat. No. 5,855,322, WO 03/041865, U.S. Pat. No. 4,415,12 and U.S. Pat. No. 4,020,979.

As far as the applicant company is aware, there are no single-dose spray devices.

Thus the present inventors found that it was possible to provide users of single-dose bottles with single-dose containers fitted with a spray tip.

In the present invention, by spray is meant droplets formed by atomization.

By single-dose bottle is meant plastic bottles containing the quantity corresponding to a single application dose of a liquid product. Such bottles are obtained by extrusion/blow moulding/filling. There may be cited by way of example the single-dose bottles of the company GILBERT marketed under the PHYSIOMER® trademark.

The single-dose container according to the invention comprises a squeeze bottle, the opening of which is surmounted by a spray tip, said tip comprising a generally cylindrical nozzle, the upper end of which comprises a spray opening and the opposite end of which is extended by a plunger of smaller diameter, said plunger being inserted into the bottle through the opening of the bottle and the lower part of the nozzle resting on the upper wall of the opening of the single-dose bottle, the nozzle and the plunger being crossed along their longitudinal axis by a traversing cavity, said traversing cavity having at the nozzle a means of creating droplets, the plunger having a free end mechanically reinforced by a means chosen from the group comprising: a bevelled form, a thread, a longitudinal traversing opening forming a bifurcation, the openings of which open onto the wall of the free end of the plunger, and their combinations.

The means of mechanical reinforcement of the free end of the plunger facilitate the insertion of the plunger into the opening of a bottle, giving it a resistance which makes it possible to avoid the deformation of said end of the plunger at the moment of the insertion. This is particularly useful in the cases where the tip is intended to be forced onto a single-dose bottle. The reinforcement can be provided by a bevelled form of the free end of the plunger. A substantial mechanical resistance can also be conferred on the free end of the plunger by virtue of the fact that the longitudinal traversing cavity forms, in the lower part of the plunger, a bifurcation, the openings of which open out symmetrically onto the wall of the free end of the plunger. The mechanical resistance can also be conferred by a thread arranged at the free end of said plunger. The thread is quite particularly suited to the case where the tip is intended to be used on single-dose bottles, the opening of which by tearing has a diameter comprised between 0.2 and 2 mm, preferably between 0.5 and 1.5 mm and even more preferably between 0.8 and 1.2 mm. The combinations of these means of mechanical reinforcement allow the mechanical resistance to the deformation experienced at the moment of the insertion of the plunger into the bottle to be increased still further.

The means of creating the droplets can be constituted by a longitudinal cavity having zones of different diameters in which is present an element allowing the forcing of the passage of the product towards the walls of the traversing cavity in its zone of larger diameter and an element allowing the forcing of the product towards the centre by giving it a swirling motion close to the spray opening. These elements can be moulded in a single piece or can be separate elements inserted into the traversing cavity of the nozzle.

Any other means can of course be used. In particular, the use of a spray opening fitted with a screen or frit may be cited.

Such means of creating droplets can be similar to those marketed by the companies REXAM or MICROSPRAY.

The form and the size of the means of creating droplets are of course adapted according to the nature of the product to be sprayed, in particular its viscosity and the use for which it is intended.

The opening of the plunger can advantageously be situated at approximately a third of the height of the bottle.

The container according to the invention is either made in a single piece, for example by extrusion/blow moulding/filling, or is manufactured in two pieces which are made into one piece after filling of the bottle.

Thus, the tip and the bottle are moulded from a single piece or else the tip is placed on the opening of a pre-filled bottle.

In this latter case, it is advantageous that the diameter of the plunger is appreciably larger than that of the opening of the single-dose bottle such that it is introduced forcefully and is not ejected when a pressure is exerted on the wall of the single-dose bottle when in use.

The tightness can be improved when the tip comprises a sealing ring which allows the free rim of the opening of the bottle to be clamped to the lower part of the sealing ring.

The external wall of the nozzle can comprise gripping zones. These gripping zones can be zones roughened such that the fingers do not slip when the tip according to the invention is placed in the opening of a single-dose bottle.

According to a preferred embodiment and taking account of the uses of the single-dose container and of its tip, these are of food- or pharmaceutical-grade plastic. All families of plastics that allow injection moulding, for example polyethylene, polyethylene terephthalate, polypropylene, etc. may be cited.

It is understood that the container and the nozzle can assume any other forms that allow an advantageous use and realization.

The invention also relates to a spray tip, said tip comprising a generally cylindrical nozzle, the upper end of which comprises a spray opening and the opposite end of which is extended by a plunger of smaller diameter, said plunger being inserted into the bottle through the opening of the bottle and the lower part of the nozzle resting on the upper wall of the opening of the single-dose bottle, the nozzle and the plunger being crossed along their longitudinal axis by a traversing cavity, said traversing cavity having at the nozzle a means of creating droplets, the plunger having a free end mechanically reinforced by a means chosen from the group comprising: a bevelled form, a thread, a longitudinal traversing opening forming a bifurcation, the openings of which open onto the wall of the free end of the plunger, and their combinations.

The spray tip is characterized by the fact that the means of creating the droplets can be constituted by a longitudinal cavity having zones of different diameters in which is present an element allowing the forcing of the passage of the product towards the walls of the traversing cavity in its zone of larger diameter and an element allowing the forcing of the product towards the centre by giving it a swirling motion close to the spray opening.

According to an advantageous embodiment, the nozzle is separated from the plunger by a tightness element. This tightness element can be a ring optionally having a slit in its lower part that allows an effective cooperation with the upper rim of the bottle onto which the tip will be able to be placed.

The external wall of the tip as defined above can, according to a preferred embodiment of the invention, comprise gripping zones preventing the fingers of the user from slipping at the moment of the insertion of the tip into the opening of a single-dose bottle.

Taking account of its use, the tip defined above is of food- or pharmaceutical-grade plastic.

The invention also relates to a kit containing a tip as defined above and at least one filled squeeze single-dose bottle with a cleavable opening.

According to the invention, the single-dose spray container, the spray tip, and the spray kit are useful for the administration of pharmaceutical or cosmetic products in particular.

The applications of the devices (single-dose spray container, tip, spray kit) are numerous. There may be cited by way of example nasal washes using a seawater solution such as PHYSIOMER®, ocular or auricular washes. In this last case, the nozzle can be fitted with an auricular cannula in order to avoid any penetration into the auricular cavity. This cannula is fitted with grooves that allow a reduction in the pressure of the ear. The nozzle can also be fitted with an anti-intrusion collar for applications into the nose of children and infants. Other applications can be topical applications in particular of cleaning, disinfectant products such as betadine, eosine, methylene blue, etc.

The device according to the invention can also be useful in the application of cosmetic products, in particular when they must be applied repeatedly over large areas of skin.

The invention will now be described in more detail with the help of practical embodiments which are non-limiting and which are illustrated by the attached drawings, in which:

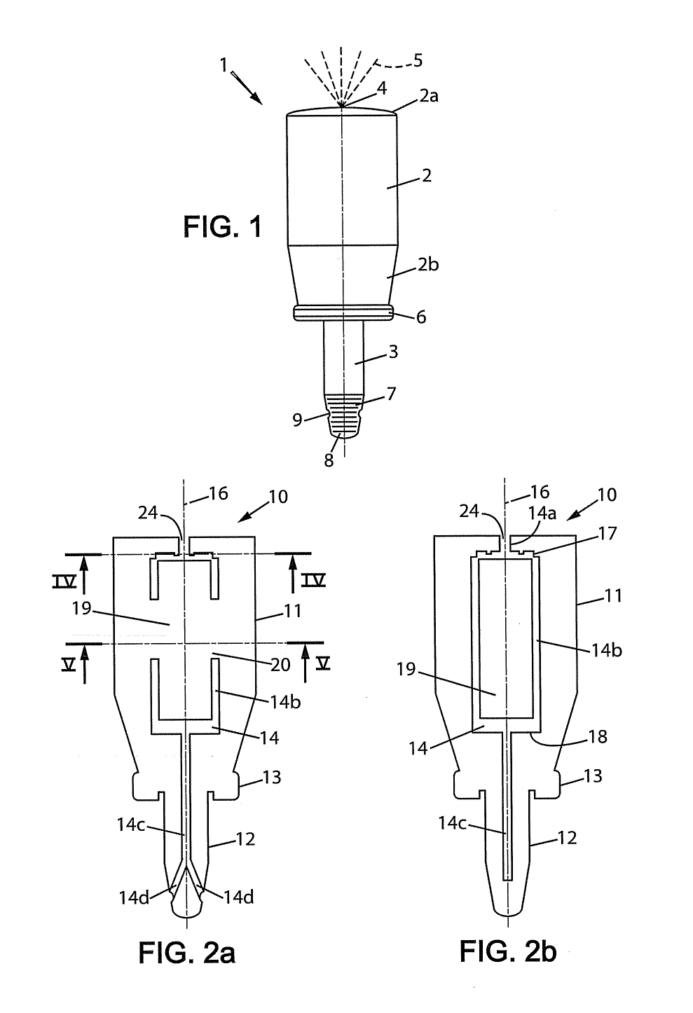

FIG. 1 is a front view of a spray tip according to the invention,

FIGS. 2a and 2b are views in longitudinal section of the tip of FIG. 1,

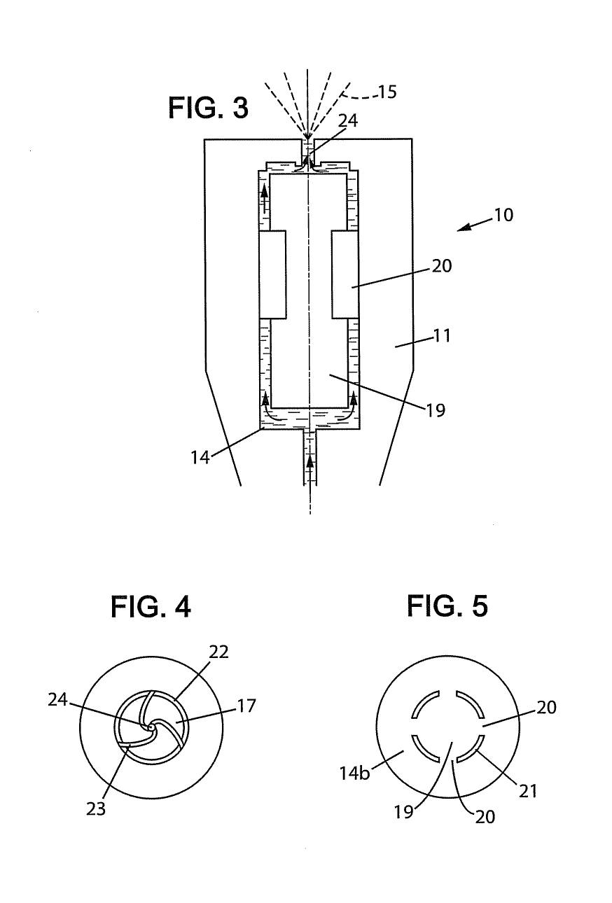

FIG. 3 is an exploded view of the nozzle of the spray tip according to the invention;

FIG. 4 is a view from below of the shoulder 17 which gives the liquid a swirling motion,

FIG. 5 is an axial section along the V-V′ axis of FIGS. 2a and 2b,

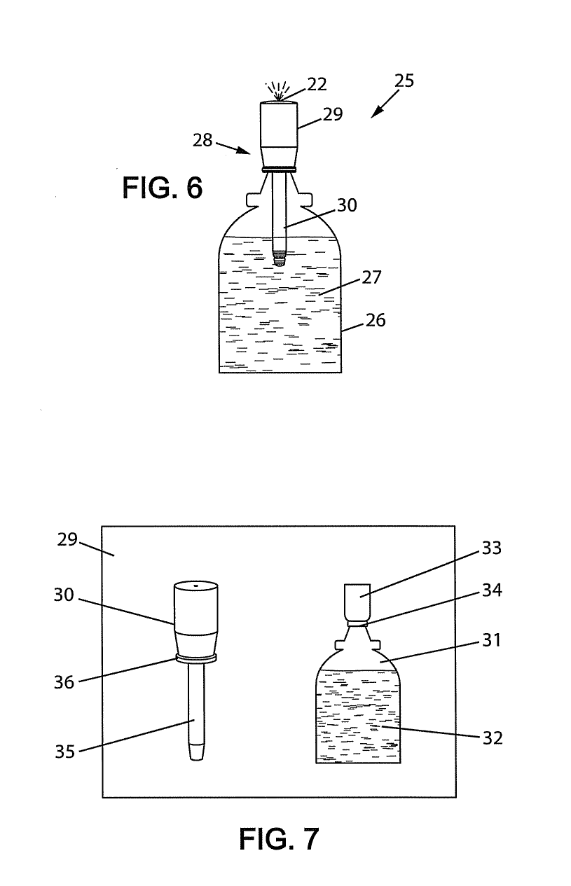

FIG. 6 shows a front view of a single-dose spray bottle according to the invention,

FIG. 7 shows a single-dose spray kit according to the invention.

FIG. 1 shows a spray tip 1 comprising a generally cylindrical nozzle 2 constituting its upper part and a plunger 3 constituting its generally cylindrical lower part that has a diameter smaller than the diameter of the nozzle 2. The upper face 2a of the nozzle comprises a central opening 4 through which the product 5 is sprayed. The lower part 2b of the nozzle is bevelled and a sealing ring 6 connects the bevelled part 2b of the nozzle to the plunger 3.

The free part of the plunger is bevelled 7 and it is fitted with a thread 8. It also comprises two diametrically opposed openings 9a that allow the product 5 to enter the spray tip 1. FIGS. 2a, 2b and 3 to 5 show in more detail a spray tip 10 according to a particular embodiment.

The spray tip 10 comprises a nozzle 11 and a plunger 12 connected by a sealing ring 13. The spray tip 10 is crossed longitudinally by a cavity 14 through which the product 15 will travel and the form of which will allow the formation of droplets.

The cavity 14 is generally cylindrical in form, centred along the longitudinal axis 16 of the tip 10. In its upper part 14a it has a very small diameter, for example of the order of 1 mm, then its diameter increases, forming a shoulder 17, for example of the order of 4 mm, and then has its maximum diameter over the whole of its central part 14b which occupies approximately the whole length of the nozzle, then a new shoulder 18 reduces the diameter of the cavity. The diameter, for example of the order of 1 mm, remains constant over the whole length of its part 14c crossing the plunger. Then this cavity 14c separates into two cavities 14d in the form of a bifurcation opening out along the bevelled wall of the plunger. The zone 14b is blocked by a generally cylindrical central element 19 which has a diameter slightly smaller than the diameter of the cavity 14b and has protrusions 20 over part of its length and over at least part of its periphery. Said protrusions 20 are of a size such that they fill the space left free between the walls of the cavity 14b and the central element 19. Slits 21 are thus formed around the closure element 19.

The shoulder 17 is shown in detail in FIG. 4, in which it is seen that it has a protrusion 22 on its external periphery and three radial protrusions 23 arranged regularly around the central opening 24.

FIG. 6 shows a single-dose spray container 25. This comprises a bottle 26 filled with liquid 27 on the opening of which is fixed a spray tip 28 comprising a nozzle 29 and a plunger 30.

An example of use will be described in connection with FIGS. 2a, 2b, 4 to 6.

During use, a pressure is exerted on the walls of the bottle 26. The liquid 27 then enters through the openings 14d of the plunger and is pushed into the cavity 14c of the plunger then forced into the cavity 14b, through the slits 21. The liquid is then projected against the shoulder 17 where it is given a swirling motion by the radial protrusions 23 before being expelled in the form of droplets through the orifice 24.

FIG. 7 shows a sales unit, for example a blister pack, comprising a spray kit according to the invention. This blister pack 29 comprises a spray tip 30 and a single-dose bottle 31 pre-filled with liquid 32 and hermetically sealed by the stopper 33.

In use, the user tears open the blister pack, removes the single-dose bottle, opens the bottle by tearing the closure along the tear line 34 and inserts the plunger 35 into the opening of the bottle, inserting it until the sealing ring 36 locks on the opening of the bottle 31.

The thus-formed spray bottle can be used as described above.

In use, the bottle can be placed in all the desired positions in so far as when a manual pressure is applied to the walls of the single-dose bottle the openings 14d of the plunger are covered with liquid to be sprayed.

What is claimed is:

1. A single-dose container comprising a squeeze bottle, the opening of which is surmounted by a spray tip, said tip comprising a generally cylindrical nozzle, the upper end of which comprises a spray opening and the opposite end of which is extended by a plunger of smaller diameter, said plunger being inserted into the bottle through the opening of the bottle and the lower part of the nozzle resting on the upper wall of the opening of the single-dose bottle, the nozzle and the plunger being crossed along their longitudinal axis by a traversing cavity, said traversing cavity having at the nozzle a means of creating droplets, the plunger having a free end mechanically reinforced by a means chosen from the group comprising: a bevelled form, a thread, a longitudinal traversing opening forming a bifurcation, the openings of which open onto the wall of the free end of the plunger, and their combinations.

2. A single-dose container according to claim 1, wherein the spray tip is fitted with a means of creating droplets constituted by the fact that the longitudinal cavity has zones of different diameters, said zone of larger diameter comprising an element allowing the forcing of the passage of the product to be sprayed towards the walls of the traversing cavity and, close to the spray opening, an element allowing the forcing of the product towards the centre by giving it a swirling motion.

3. A single-dose container according to claim 1, characterized by the fact that the opening of the plunger is situated at approximately a third of the height of the bottle.

4. A single-dose container according to claim 1, wherein the tip is locked onto the opening of the bottle.

5. A single-dose container according to claim 1, wherein the tip and the bottle are in a single piece.

6. A single-dose container according to claim 1, wherein the external wall of the nozzle comprises gripping zones.

7. A single-dose container according to claim 1, wherein the tip and the bottle are of food- or pharmaceutical-grade plastic.

8. A spray tip comprising a generally cylindrical nozzle, the upper end of which comprises a spray opening and the opposite end of which is extended by a plunger of smaller diameter, the nozzle and the plunger being crossed along their longitudinal axis by a traversing cavity, said traversing cavity having at the nozzle a means of creating droplets, the plunger having a free end mechanically reinforced by a means chosen from the group comprising: a bevelled form, a thread and a longitudinal traversing opening forming a bifurcation, the openings of which open onto the wall of the free end of the plunger, and their combinations.

9. A spray tip according to claim 8, wherein the means of creating the droplets is constituted by the fact that the longitudinal cavity has zones of different diameters, said zone of larger diameter comprising an element allowing the forcing of the passage of the product to be sprayed towards the walls of the traversing cavity and, close to the spray opening, an element allowing the forcing of the product towards the centre by giving it a swirling motion.

10. A spray tip according to claim 8, wherein the external wall of the nozzle comprises gripping zones.

11. A spray tip according to claim 8, wherein it is of food- or pharmaceutical-grade plastic.

12. A kit containing a tip as defined in claim 8, and at least one filled squeeze single-dose bottle with a cleavable opening.

13. Use of a single-dose container according to claim 1, for the application by spraying of a pharmaceutical product or a cosmetic product.

14. Use of a spray tip according to claim 8 for the application by spraying of a pharmaceutical product or a cosmetic product.

15. Use of a kit according to claim 12 for the application by spraying of a pharmaceutical product or a cosmetic product.
